(19) United States
(12) Patent Application Publication
(10) Pub. No.: US 2014/0348983 A1
(43) Pub. Date: Nov. 27, 2014

(54) Edible Nutritional Compositions/Products Fortified with Iron (II) Mineral Sources

(71) Applicant: OTC Nutrition LLC, Manhattan, KS (US)

(72) Inventor: David K. Yang, Manhattan, KS (US)

(73) Assignee: OTC Nutrition LLC, Manhattan, KS (US)

(21) Appl. No.: 14/371,748

(22) PCT Filed: Jan. 15, 2013
(86) PCT No.: PCT/US13/21526

§ 371 Date: Jul. 11, 2014

Related U.S. Application Data
(60) Provisional application No. 61/588,680, filed on Jan. 20, 2012.

(51) Int. Cl. A23L 1/304; A23L 2/02; A23L 1/22

(52) U.S. Cl. CPC A23L 1/304; A23L 1/22075; A23L 2/02
USPC 426/74; 426/590; 426/540

(57) ABSTRACT

Edible compositions or products which are nutritionally supplemented with one or more iron (II) mineral sources, one or more high ferric ion reducing agents such as ascorbic acid, edible ascorbic acid salts, edible ascorbic acid esters, erythorbic acid, edible erythorbic acid salts, or edible erythorbic acid esters, an edible carboxylic acid component, such as a citric acid and malic acid component, to lower the pH of such products to about 4.5 or less (e.g., about 4.0 or less), and one or more calcium mineral sources which can be solubilized by the edible carboxylic acid component and which ameliorate the sour taste of the edible carboxylic acid component.

### CROSS-REFERENCE TO RELATED APPLICATIONS

This application makes reference to and claims the benefit of the following co-pending U.S. Provisional Patent Application No. 61/588,680, filed Jan. 20, 2012. The entire disclosure and contents of the foregoing Provisional Application is hereby incorporated by reference.

### FIELD OF THE INVENTION

The present invention broadly relates to edible nutritional compositions or products which are fortified with one or more iron (II) mineral sources, and include one or more edible high ferric ion reducing agents such as ascorbic acid, edible ascorbic acid salts, edible ascorbic acid esters, erythorbic acid, or edible erythorbic acid salts, an edible carboxylic acid component, such as a citric acid and malic acid component, to lower the pH of such compositions/products to about 4.5 or less (e.g., about 4.0 or less), and one or more calcium mineral sources which can be solubilized by the edible carboxylic acid component and which ameliorate the sour taste of the edible carboxylic acid component.

### BACKGROUND

Mineral and vitamin supplements are recognized to be important for those who have inadequate diets, including children. In order to alleviate the problem of improper diet, supplementation of such diets with certain minerals and vitamins, such as by the use of vitamin pills, fortified foods (e.g., fortified beverages), other nutritional supplements, etc., may be required.

Several minerals may be necessary for complete nutrition, and calcium is one of the most vital of these minerals. Calcium is the fifth most abundant element in the human body, and plays an important role in many physiological processes, including nerve and muscle functions. Calcium deficiency may interfere with muscular contraction and can also result in depletion of skeletal calcium. Osteoporosis is also a recognized nutritional problem, and numerous calcium fortified compositions are presently being marketed in an attempt to overcome this problem.

Iron supplementation may also be required for some individuals who suffer (or may suffer) from iron deficiency in the diet. Iron stored in the body is generally depleted over time, thus potentially creating an iron deficiency. Such iron deficiency in certain individuals may eventually cause anemia. In this regard, nutritional supplements containing iron may be taken orally to provide iron fortification, using, for example, ferrous salts such as ferrous sulfate sold commercially in iron supplements under the trade names Feratab, Fer-Iron, etc.

Of the vitamins, ascorbic acid (vitamin C) may be considered one of the more essential because of the important role played by this vitamin in collagen formation, teeth and bone formation and repair, in the prevention of scurvy, etc. Ascorbic acid may be found naturally in many fruits and vegetables, but because this vitamin is water soluble, ascorbic acid may not be stored in the body for any appreciable period of time. For these reasons, ascorbic acid may be included in various fortified beverages now being marketed so that it may be consumed on a daily basis. Beside vitamin fortification, ascorbic acid (including its asorbate salts) may be included in various formulations as an antioxidant.

Nutritional supplementation, especially fortification of foods such as beverages, with these various minerals and vitamins may be difficult for many reasons. These minerals and vitamins may interact (e.g., react) with other components in such products, including other minerals and vitamins. In fact, as the number of minerals and vitamins in such products increases, the problem of adverse interaction between these mineral and vitamins likewise grows greater. For example, the mineral cations present in oxidative environments that often exist in such products may react, degrade, etc., thus depleting the amount of the mineral source present in the product, causing unacceptable taste, as well as undesirable discoloration issues in the product, etc. As a result, mineral and vitamin fortification of foods, such as in beverage products, for example, fruit juices and juice beverages which may contain many reactive components, may necessitate compromises in such fortification (e.g., such minerals and vitamins may only be present in minimal or trace amounts) to lessen the potential impact of such undesirable mineral and vitamin interactions in such reactive environments to avoid other impacts (e.g., undesirable taste and discoloration) on consumer acceptance of such products.

### SUMMARY

According to a first broad aspect of the present invention, there is provided a product comprising an edible nutritional composition containing:
a nutritionally supplemental amount of one or more iron (II) mineral sources;
one or more edible high ferric ion reducing agents in amount sufficient to measurably retard conversion of the iron (II) mineral sources from ferrous to ferric species;
an edible carboxylic acid component in an amount sufficient to lower the pH of the composition to about 4.5 or less (e.g., about 4.0 or less); and
one or more calcium mineral sources which can be solubilized by the edible carboxylic acid component and which are in an amount sufficient to ameliorate the sour taste of the edible carboxylic acid component.

According to a second broad aspect of the present invention, there is provided a product comprising a nutritionally supplemented liquid beverage composition having a pH of about 4.0 or less, and containing:
a nutritionally supplemental amount of one or more iron (II) mineral sources;
one or more edible high ferric ion reducing agents selected from the group consisting of ascorbic acid, edible ascorbic acid salts, edible ascorbic acid esters, erythorbic acid, edible erythorbic acid salts, and edible erythorbic acid esters in amount sufficient to measurably retard conversion of the iron (II) mineral sources from ferrous to ferric species;
an citric acid and malic acid component in an amount sufficient to lower the pH of the composition to about 4.0 or less, and in a weight ratio of citric acid to malic acid of from about 2:1 to about 1:3; and
one or more calcium mineral sources which can be solubilized by the edible citric and malic acid component and which are in an amount sufficient to ameliorate the sour taste of the citric acid and malic acid component.

According to a third broad aspect of the present invention, there is provided a process for preparing an edible nutritional composition, which comprises the following steps:
(a) combining a mixture of an edible carboxylic acid component in an amount sufficient to lower the pH of the edible nutritional composition to about 4.5 or less (e.g., about 4.0 or less), and a nutritionally supplemental amount of one or more iron (II) mineral sources, with an aqueous solution of one or more edible high ferric ion reducing agents in an amount sufficient to measurably retard conversion of iron (II) mineral sources from ferrous to ferric species to provide a solution of iron (II) mineral sources in a stable high ferric ion reducing potential environment;
(b) combining one or more calcium mineral sources which can be solubilized by the edible carboxylic acid component with the solution of step (a) in an amount sufficient to ameliorate the sour taste of the edible carboxylic acid component; and
(c) combining with the solution of step (b) any remaining components of the edible nutritional composition to provide a prepared edible nutritional composition having a pH of about 4.5 or less (e.g., about 4.0 or less).

According to a fourth broad aspect of the present invention, there is provided a process for preparing a nutritionally supplemented liquid beverage composition, which comprises the following steps:
(a) forming an aqueous solution of one or more high ferric ion reducing agents selected from the group consisting of ascorbic acid, edible ascorbic acid salts, edible ascorbic acid esters, erythorbic acid, edible erythorbic acid salts, and edible erythorbic acid esters in an amount sufficient to measurably retard conversion of iron (II) mineral sources from ferrous to ferric species;
(b) combining a mixture of the citric acid and malic acid component in an amount sufficient to lower the pH of the edible nutritional composition to about 4.0 or less, and in a weight ratio of citric acid to malic acid of from about 2:1 to about 1:4, and a nutritionally supplemental amount of one or more iron (II) mineral sources with the aqueous solution of step (a) to form a solution of iron (II) mineral sources in a stable high ferric ion reducing potential environment;
(c) adding one or more calcium mineral sources which can be solubilized by the citric acid and malic acid component to the solution of step (b) in an amount sufficient to ameliorate the sour taste of the citric acid and malic acid component; and
(d) adding to the solution of step (c) any remaining components of the edible nutritional composition to provide a prepared nutritionally supplemented liquid beverage composition having a pH of about 4.0 or less.

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the terms “edible,” refers to any product, composition, ingredient, additive, material, etc., which may be orally ingested, and which is generally safe for humans, other animals, etc., to eat. Edible products and edible compositions, may include, for example, foods (e.g., beverages, pet foods, etc.), nutritional supplements, etc.

For the purposes of the present invention, the terms “food”, “food ingredient” or “food product” refer to the common meaning of these terms and include any product classified as a “food” by the U.S. Food and Drug Administration, including weight loss products, meal replacement products, etc. Food products may include any product that may be directly drunk or ingested or that may be further mixed with other ingredients, further processed, etc., to form a product that may be drunk or ingested. For example, a food product may be mixed with a liquid to form a drink, added to flour and baked to form a bakery product, etc. A food product of the present invention may in various forms such as, for example, a liquid, a frozen or semi-frozen liquid, a nutritional supplement, a nutritional bar, a nutritional beverage, a candy bar, a powder (e.g., a beverage powder, etc.), a baked good (e.g., a cookie, a cake, etc.), pudding, sauce, gravy, soup, broth, soup consommé, cake frosting, ice cream, yogurt, custard, gelatin dessert, apple sauce, cottage cheese, cereal, bread, cheese, cheese spreads, chocolate (e g., milk chocolate), liquid drinks such as fruit juices such as: apple juice, orange juice, grape juice, grapefruit juice, cranberry juice, etc., vegetable juices such as tomato juice, carrot juice, etc., mixtures of fruit and/or vegetable juices, coffee, tea, milk, milkshakes, hot chocolate, espressos, cappuccinos, lattés, etc.

For the purposes of the present invention, the term “food additive” refers to the common meaning of the term “food additive” and includes any product classified as a “food additive” by the U.S. Food and Drug Administration. Food additives may include non-caloric sweeteners, colorants, bulking agents (e.g., polydextrose), fat substitutes such as olestra, etc.

For the purposes of the present invention, the term “nutritional supplement” refers to a product, composition, etc., which may provide nutritional benefits in terms of, for example, providing nutritional minerals, vitamins, etc. Nutritional supplements may include tablets, gels, gel capsules (gel-caps), liquid concentrates (e.g., in the form of a liquid mineral fortified concentrate which is dilutable in a volume ratio of concentrate:water of from about 1:1 to about 1:4), powders, syrups, energy beverages (e.g., energy drinks, etc.), etc.

For the purposes of the present invention, the term “nutritionally supplemental amount” refers to an amount of a nutritional mineral source, vitamin, etc., which provides a measurable nutritional benefit to the individual consuming the edible nutritional product, composition, etc. Nutritionally supplemental amounts of a particular nutritional mineral source, vitamin, etc., may be measured in terms of RDA values.

For the purposes of the present invention, the term “RDA” refers to the Recommended Dietary Allowances for minerals, vitamins, etc., including iron (II) mineral sources, calcium mineral sources, other trace minerals, vitamin C, vitamin D, etc. These Recommended Dietary Allowances (RDAs) are a set of estimated nutrient allowances established by the National Academy of Sciences, which are updated periodically to reflect current scientific knowledge.

For the purposes of the present invention the term “serving” refers to the appropriate serving size for a food product, for example, a nutritional beverage, weight loss product, meal substitute, etc., a nutritional supplement, etc., as established by the United States Food and Drug Administration (FDA) and the Nutrition and Labeling Act (NLEA), as set forth in 21 C.F.R. §101, or any subsequent version of the FDA regulatory rules that may correspond to 21 C.F.R. §101. The present invention also adopts the NLEA's definition of a serving size as being the amount of food customarily eaten at one time. When the food product of the present invention comprises a nutritional beverage or liquid meal substitute, a typical serving size may be from about 230 to about 530 mL. A single serving of the food product may be packaged in various types of, for example, “single serving” packages/containers that are well known in the art.

For the purposes of the present invention, the terms “solids basis” and “dry basis” refer interchangeably to the weight percentage of each of the respective solid compounds, components, ingredients, materials, substances, etc. (e.g., iron (II) mineral sources, edible high ferric ion reducing agents, edible carboxylic acid component, calcium mineral sources, other trace minerals, vitamins, etc.) present in the absence of any liquids (e.g., water). Unless otherwise specified, all percentages given herein for solid compounds, components, ingredients, materials, substances, etc., are on a solids basis.

For the purposes of the present invention, the terms “container” and “package” are used interchangeably and refer to a package or container that contains the food product of the present invention. The specific type of package or container, either of a single-serving size or any other size, used as a container for the food product may depend on such factors as whether the food product is a liquid, solid, powder, etc. whether the food product includes perishable components, components that need to be refrigerated, etc.

For the purposes of the present invention, the term “liquid food” or “liquid nutritional supplement” refers to any food or nutritional supplement product that is liquid at room temperature. Liquid foods or liquid nutritional supplements may be in the form of solutions, colloidal suspensions, thixotropic mixtures, etc., for example, aqueous foods (i.e., those comprising water as a suspending agent, solubilizing agent, carrier, etc., with or without other suspending agents, solubilizing agents, carriers, etc., such, as for example, alcohol, etc.). Examples of liquid foods may include: bottled water, carbonated beverages (e.g., soda), fruit juices, vegetable juices, coffee, tea, milk, shakes, ice cream, puddings, pie fillings, etc. Examples of liquid nutritional supplements may include: liquid concentrates (e.g., in the form of a liquid mineral fortified concentrate which is dilutable in a volume ratio of concentrate:water of from about 1:1 to about 1:4), gels, gel capsules (gel-caps), extracts, syrups, energy beverages (e.g., energy drinks, etc.), etc.

For the purposes of the present invention, the terms “ready-to-eat” (R-T-E) or “ready-to-drink” (R-T-D) refer, respectively, to a food product or a beverage product that is essentially ready for human consumption with minimal or no additional preparation such as cooking, heating, etc.

For the purposes of the present invention, the term “iron (II) mineral source” refers to any source of iron which may provide nutritional benefit, and which may exist in the divalent state (e.g., are “ferrous” compounds/salts). Suitable iron (II) mineral sources may include one or more of: ferrous bis-glycinate (Ferrochel), ferrous glycine sulfate (ferroglycine sulfate), ferrous fumarate, ferrous gluconate, ferrous succinate, ferrous lactate, ferrous tartrate, ferrous citrate, ferrous sulfate, ferrous ammonium sulfate, ferrous iodide, etc.

For the purposes of the present invention, the term “calcium citrate malate complex” refers to an at least meta-stable complex of calcium with citrate and malate anions. Besides increasing calcium solubilization, another benefit of calcium citrate malate is that this complex does not interfere, or at least does not interfere in a significant way with the bioavailability or absorption of other minerals, including trace minerals.

For the purposes of the present invention, the term “calcium mineral source” refers to any source of calcium which may form a calcium citrate malate complex. Besides forming a calcium citrate malate complex, such calcium mineral sources may additionally provide a nutritional benefit. These calcium mineral sources may include one or more of: calcium hydroxide, calcium oxide, calcium chloride, calcium citrate, calcium malate, calcium citrate malate, calcium carbonate, calcium phosphates/calcium hydrogen phosphates (e.g., monobasic calcium phosphate, dibasic calcium phosphate, tricalcium phosphate, etc.), calcium sulfate, calcium lactate, calcium benzoate, calcium ascorbate, calcium sorbate, calcium lactate gluconate, calcium propionate, calcium acetate, calcium caseinate, calcium cyclamate, calcium panthothenate, calcium stearate, calcium stearyl lactylate, calcium tartrate, etc.

For the purposes of the present invention, the term “high ferric ion reducing agent” refers to an agent which measurably retards the tendency of ferrous cationic species to be oxidized (converted) to ferric cationic species (i.e., tends to reduce the ferric species and thus creates a high reducing potential environment for the ferrous species). Edible high ferric ion reducing agents may include one or more of: ascorbic acid, edible ascorbic acid salts (e.g., sodium ascorbate, potassium asorbate, etc.), edible ascorbic acid esters (e.g., ascorbyl palmitate, ascorbyl stearate, etc.), erythorbic acid (the stereoisomer of ascorbic acid), or edible erythorbic acid salts (e.g., sodium erythorbate, potassium erythorbate, etc.), edible erythorbic acid esters (e.g., erythorbyl palmitate, erythorbyl stearate, etc.), etc.; sulfites, such as sodium sulfite, potassium sulfite, etc.; etc. Besides functioning as a high ferric ion reducing agent, any ascorbic acid and/or edible ascorbic acid salts present may additionally provide nutritional benefit as a source of vitamin C, may impart other antioxidant benefits, etc.

For the purposes of the present invention, the term “edible carboxylic acid” refers to any carboxylic acid that is edible, has one or more carboxy groups, and which may be used to adjust (e.g., reduce) the pH of a composition or product (i.e., are acidulants). Edible carboxylic acids may include one or more of: citric acid, malic acid, fumaric acid, maleic acid, tartaric acid, succinic acid, malonic acid, glutaric acid, adipic acid, aspartic acid, glutaconic acid, glutamic acid, phosphoric acid, etc., as well as any salts thereof (e.g., sodium salt, potassium salt, calcium salt, magnesium salt, etc.) While ascorbic acid and erythrobic acid are also edible and have carboxy groups, such acids are not used herein to adjust the pH of the composition or product, but are instead used as edible high ferric ion reducing agents.

For the purposes of the present invention, the term “high acid environment” refers to a composition or product having a pH of about 4.5 or less (e.g., about 4.0 or less). For example, a high acid environment may have a pH of from about 2.1 to about 4.0, such as from about 3.4 to about 3.8.

For the purposes of the present invention, the term “total acids” refers to the combined amount of edible carboxylic acids present in the composition or product, such as citric acid and malic acid.

For the purposes of the present invention, the term “bioavailable” refers to a mineral source (e.g., an iron (II) mineral source, a calcium mineral source, etc.) which is available for absorption by the gut.

For the purposes of the present invention, the term “vitamin C” refers to compounds, compositions, etc., which may include ascorbic acid (L-ascorbic acid), edible salts of ascorbic acid (L-ascorbate salts), etc., as well as mixtures thereof.

For the purposes of the present invention, the term “vitamin D” refers to compounds, compositions, etc., which may include vitamin D3, vitamin D2, 25(OH)D₃, 25(OH)D₂, 1α,25(OH)₂ D₃, 1α,25(OH)₂D₂, etc., as well as mixtures thereof.

For the purposes of the present invention, the term “trace minerals” refers to those minerals which are important for bone growth and age-related bone health. These trace minerals may include zinc, magnesium, manganese, copper, potassium, etc., as well as mixtures thereof.

For the purposes of the present invention, the term “anthocyanins” refer to water-soluble vacuolar pigments in the form of polyphenolic flavanoid compounds, compositions, etc., which are derived from fruits and vegetables. Anthocyanins may appear as red, purple, blue, etc., pigments. Anthocyanins may be derived (e.g., as juices), for example, from one or more of the following: blueberries, cranberry, bilberry, black raspberry, red raspberry, blackberry, black currant, cherry, concord grape, black chokeberry, acai, beet, eggplant, tea leaves, etc.

For the purposes of the present invention, the term “fruit juice product” refers to both fruit juice beverages and fruit juice concentrates which comprise at least about 5% fruit juice on a single-strength basis.

For the purposes of the present invention, the term “fruit juice-based beverage” refers to a fruit juice product which is in a single-strength, ready-to-serve, drinkable form. For the purposes of the present invention, the terms “single-strength” and “ready-to-serve” are used interchangeably. Fruit juice beverages may be of the “partial strength” type which may comprise up to about 40% fruit juice by weight of the beverage, for example, from about 5 to about 20% fruit juice (e.g., from about 5 to about 10 fruit juice), or may be of the “full-strength” type which may comprise greater than about 40% fruit juice, for example, at least about 95% fruit juice. Fruit juice beverages may also include extended juice products which are referred to as “nectars” which may comprise from about 50 to about 90% fruit juice, for example, from about 50 to about 70% fruit juice.

For the purposes of the present invention, the term “fruit juice concentrate” refers to a fruit juice product which, when diluted with the appropriate amount of water, forms drinkable fruit juice-based beverages. Fruit juice concentrates may be formulated, for example, to provide drinkable beverages when diluted with 3 to 5 parts by weight water.

For the purposes of the present invention, the term “concentrated fruit juice” refers to fruit juice from which a portion of the water has been removed.

For the purposes of the present invention, the term “fruit juice materials” refers to fruit juice, plus other fruit juice materials such as, for example, fruit juice aroma and flavor volatiles, peel oils, pulp or pomace, etc.

For the purposes of the present invention, the term “fruit juice” refers to citrus juices, noncitrus juices such as apple juice, grape juice (e.g., from concord grapes, etc.), pear juice, cherry juice, berry juice (e.g., from blueberries, cranberry, bilberry, black raspberry, red raspberry, blackberry, chokeberry, etc.), black currant juice, acai juice, pineapple juice, peach juice, apricot juice, plum juice, prune juice, etc., as well as mixtures of these juices.

For the purposes of the present invention, the term “citrus juice” refers to fruit juices selected from orange juice, lemon juice, lime juice, grapefruit juice, tangerine juice etc., and mixtures of these juices.

For the purposes of the present invention, the term “solids content” refers to the percentage of non-volatile, non-liquid compounds, components, ingredients, materials, substances, etc., (by weight) that are present in the composition, product, etc.

For the purposes of the present invention, the term “liquid” refers to a non-gaseous fluid composition, compound, material, etc., which may be readily flowable at the temperature of use (e.g., room temperature) with little or no tendency to disperse and with a relatively high compressibility.

For the purposes of the present invention, the term “room temperature” refers to the commonly accepted meaning of room temperature, i.e., an ambient temperature of 20° to 25° C.

For the purposes of the present invention, the term “comprising” means various compounds, components, ingredients, substances, materials, layers, steps, etc., may be conjointly employed. Accordingly, the term “comprising” encompasses the more restrictive terms “consisting essentially of” and “consisting of.”

### Description

The present invention broadly relates to edible nutritional compositions or products which may provide food (e.g., liquid beverage) products fortified with divalent minerals (i.e., ferrous/iron (II) and calcium) to deliver nutritionally beneficial and meaningful amounts of such divalent minerals, especially ferrous/iron (II), within a high ferric ion reducing potential oxidation-reduction (redox) environment that minimizes, reduces, diminishes, inhibits, retards, avoids, prevents, etc., unacceptable taste and color development, even when used to supplement fruit juices rich in anthocyanins and similar flavanoids. Providing edible nutritional compositions or products, such as liquid nutritionally fortified beverage compositions or products, which contain such catalytically active polyvalent mineral cations such as iron may create some significant challenges. In choosing appropriate mineral fortification of edible nutritional compositions, as well as liquid nutritionally supplemented beverages, not only may organoleptic qualities be important, but also maximization of the nutritional bioavailability of the mineral source may be required and/or desirable. For example, water-soluble iron compounds are the most nutritionally bioavailable iron sources. But inclusion of such iron mineral sources in edible nutritional compositions or products, such as liquid nutritionally fortified beverage compositions or products, may cause adverse interactions (e.g., reactions) with other components (e.g., anthocyanins, other flavanoids, etc.), thus causing degradation of, depletion of, chemical changes in, etc. such other components, as well as the iron mineral source, as well as causing undesirable taste effects (e.g., unacceptable metallic aftertaste), discoloration effects, oxidative deterioration of flavors, etc., in such compositions or products.

Highly soluble mineral sources, for example, iron (II) mineral sources, such as ferrous bis-glycinate (an amino-acid chelated iron (II) source), may provide in edible nutritional supplements, such as fortified foods and liquid beverages, a more bioavailable source of such minerals. But inclusion of such mineral sources without compromising consumer taste acceptance may present unique challenges. While iron (II) mineral sources, such as ferrous bis-glycinate, may be used to minimize, reduce, diminish, inhibit, retard, avoid, prevent, etc., iron-mediated metallic aftertastes, like those caused by other water-soluble iron compounds, ferrous bis-glycinate may be easily oxidized to the ferric iron (III) cationic species in an aqueous solution. The creation of such ferric iron (III) cationic species may cause further off-flavor development, off-color development, etc., in such aqueous solutions. For example, ferrous bis-glycinate by itself, when added to water or other aqueous solutions, may impart a deep rusty yellow color which may cause unacceptable off-color development in, for example, liquid beverages by interacting with flavanoids, including color and flavor compounds such as anthocyanins. Anthocyanins may be commonly found in many fruits and vegetables and richly concentrated in berries, such as blueberries, cranberry, bilberry, black raspberry, red raspberry, blackberry, black currant, cherry, concord grape, black chokeberry, acai, beet, eggplant, tea leaves, etc. Accordingly, consumption of such fruits high in anthocyanins may provide potential health benefits in terms of cancer, aging, neurological diseases, inflammation, diabetes, bacterial infections, etc. But when present, anthocyanins may also be highly reactive when exposed to air, and may thus react and cause degradation of other fruit components, such as ascorbic acid, even at pHs as low as, for example, about 2.0 in which anthocyanins may be more stable. (Such oxidative reactions of anthocyanins may also be further catalyzed by the presence of iron and copper.)

In aqueous compositions and products having a pH less than about 5, a ferric ion reducing agent (hereafter referred to as “high ferric ion reducing agent”), such as ascorbic acid, erythorbic acid, etc., may be used to minimize, reduce, diminish, inhibit, avoid, prevent, retard etc., oxidation of ferrous cationic species to the respective ferric cation species. See Mehansho, Nutr. 136: 1059-1063 (2006). But the presence of components, such as anthocyanins, may cause interaction with, as well as depletion of, such high ferric ion reducing agents, including ascorbic acid, erythorbic acid, etc. Such degradation/depletion of high ferric ion reducing agents, such as ascorbic acid, erythorbic acid, etc., may thus lower the reduction potential environment to minimize, reduce, diminish, inhibit, avoid, retard, prevent, etc., the oxidation and conversion of ferrous (II) cationic species to ferric (III) cationic species.

Embodiments of the edible nutritional compositions or products, such as nutritionally supplemented liquid beverage compositions or products, of the present invention allow, permit, enable, etc., fortification with nutritionally meaningful amounts of divalent minerals, including iron (II) minerals sources such as ferrous bis-glycinate (even in the presence of fruit juices in juice beverages which may be rich in anthocyanins and similar flavanoids) without imparting objectionable taste, aftertaste, color, etc., while also preserving, improving, etc., nutrient bioavailability of the iron (II) mineral sources. These benefits in terms of delivering biovailable divalent mineral cations, such as iron (II) mineral sources in nutritionally meaningful amounts, even in the presence of such anthocyanins and similar flavanoids, is achieved by creating a high ferric ion reducing potential environment, that uses, in combination: (a) one or more high ferric ion reducing agents, for example, selected from ascorbic acid, edible ascorbic acid salts, edible ascorbic acid esters, erythorbic acid, edible erythorbic acid salts, or edible erythorbic acid esters; and (b) an edible carboxylic acid component, such as a citric acid and malic acid component, to reduce or lower the pH of such compositions or products to 4.5 or less (e.g., about 4.0 or less), for example, in the range of from about 2.1 to about 4.5, (e.g., from about 2.1 to about 4.5, such as from about 3.4 to about 3.8) to minimize, reduce, diminish, inhibit, retard, avoid, prevent, etc., degradation of, depletion of, etc., the high ferric ion reducing agents. The edible carboxylic acid component (e.g., citric acid and malic acid component) may be present, for example, in an about of at least about 0.40% by weight of the composition or product, such as from about 0.40 to about 1.20% by weight (e.g., from about 0.60 to about 1.20% by weight) of the composition or product, e.g., from about 0.70 to about 0.85% by weight of the composition or product. In some embodiments using a citric acid and malic acid component, the amount, respectively, of citric acid may be in the range of from about 0.18 to about 0.60% by weight of the composition or product, while the amount of malic acid may be, for example, in the range of from about 0.22 to about 0.60% by weight of the composition or product. In those embodiments using a citric acid and malic acid component, the citric acid and malic acid may be in a weight ratio of from about 2:1 to about 1:4, such as from about 5:4 to about 1:3, e.g., a weight ratio of citric acid to malic acid of about 2:3.

While the edible carboxylic acid component (e.g., citric acid and malic acid component) is included to achieve a high ferric ion reducing potential environment by lowering the pH to about 4.5 or less (e.g., about 4.0 or less), such acidity created by the edible carboxylic acid component may also impart, cause, create, etc., undesirable sour and tart tastes. Accordingly, in embodiments of the edible nutritional compositions or products of the present invention, a calcium mineral source which can be solubilized by the edible carboxylic acid component is used to ameliorate the sour taste of this edible carboxylic acid component. Inclusion of the solubilized calcium mineral source not only improves the sour taste balance of the edible nutritional composition or product, but may also aid in sequestering the ferrous ion species (of the iron (II) mineral source) from being oxidized to the ferric species, as well as being involved in other degradative reactions.

Embodiments of the edible nutritional composition or product, as well as embodiments of the nutritionally supplemented liquid beverage composition or product of the present invention contain a nutritionally supplemental amount of one or more iron (II) mineral sources, as defined above. For example, the iron (II) mineral source may be present in the composition or product in an amount of from about 7 to about 40 ppm (iron metal basis), such as from about 7 to about 25 ppm. The iron (II) mineral source may be present in the product or composition in an amount sufficient to provide at least about 10% of the RDA of iron, such as from about 10 to about 50% of the RDA of iron, e.g., from about 10 to about 30% of the RDA of iron.

The calcium mineral source, as defined above, may be present in the edible nutritional composition or product in an amount sufficient to ameliorate the sour taste of the edible carboxylic acid component (e.g., the citric acid and malic acid component) and may also form a solubilized calcium complex with the edible carboxylic acid component (e.g., a solubilized calcium citrate malate complex). The amount of the calcium source may be in an amount sufficient to provide at least about 0.04% solubilized calcium by weight of the composition or product, such as at least about 0.12% by weight of the composition or product. For example, the amount of calcium may be in an amount sufficient to provide from about 0.04% to about 0.22% solubilized calcium by weight of the composition or product. The amount of the calcium mineral source present in the may also provide at least about 10% of the RDA of calcium, such as at least about 30% of the RDA of calcium. For example, the calcium mineral source may be in an amount sufficient to provide from about 10 to about 50% of the RDA of calcium, such as from about 10 to about 30% of the RDA of calcium.

The high ferric ion reducing agents present in embodiments of the edible nutritional composition or product, as well as embodiments of the nutritionally supplemented liquid beverage composition or product of the present invention, may, for example, be selected from ascorbic acid, edible ascorbic acid salts, edible ascorbic acid esters, erythorbic acid, edible erythorbic acid salts, or edible erythorbic acid esters, as defined above. These one or more high ferric ion reducing agents are present in these compositions or products in an amount sufficient to measurably retard conversion of the iron (II) mineral sources from ferrous to ferric species. The ascorbic acid, edible ascorbic acid salts and/or edible ascorbic acid esters may be present, for example, in an amount of at least about 0.035% by weight of the composition or product, such as at least about 0.08% by weight of the composition or product. In some embodiments, the ascorbic acid, edible ascorbic acid salts, and/or edible ascorbic acid esters may be present in an amount of from about 350 to about 850 ppm, such as from about 600 to about 850 ppm. The erythorbic acid, edible erythorbic acid salts, and/or edible erythorbic acid esters may be present, for example, in amount at least about 0.02% by weight of the composition or product, such as at least about 0.055% by weight of the composition or product. In some embodiments, the erythorbic acid, edible erythorbic acid salts, and/or edible erythorbic acid esters may be present in an amount of from about 200 to about 600 ppm, such as from about 500 to about 600 ppm.

The embodiments of the liquid edible nutritional products or compositions of the present invention may include any product form comprising the essential ingredients described herein, and which is safe and effective for oral administration, ingestion, etc. The liquid edible nutritional products or compositions may be formulated to include only the essential ingredients described herein, or may be modified with optional ingredients to form a number of different product forms. The liquid edible nutritional products or compositions of the present invention may be formulated as dietary product forms, which are defined herein as those embodiments comprising the essential ingredients of the present invention in a product form that then contains fat, protein, and carbohydrate, etc., and may also contain other minerals, vitamins, etc., or combinations thereof.

The embodiments of the edible nutritional products or compositions of the present invention may be in the form of viscous liquid food products, including food condiments (e.g., spreads, sauces, jams, jelly, coffee creamer, ketchup, mustard or sweetener), chocolate syrup, baking or cooking materials (e.g., fat substitutes or oil substitutes, butter substitutes or margarine substitutes), beverages (e.g., expresso, shakes, ice-cream based drinks), flowable cheeses, cream cheese, dips, dressings, frozen desserts (e.g., ice cream, fudge bars, frozen yogurt), pudding, flavored refrigerated dough (e.g., cookies, bread, brownies), milk or soy-based smoothies, yogurt or yogurt-based drinks, frozen yogurt, soy milk, soups, etc.

Embodiments of the edible nutritional products or compositions of the present invention may desirably contain other minerals, vitamins, etc., in addition to iron (II) mineral sources, calcium mineral sources, vitamin C (e.g., as L-ascorbic acid or its edible salt). Those skilled in the art will appreciate that minimum requirements may have been established for these other minerals and vitamins that are known to be necessary for normal physiological function. Those skilled in the art will also understand that appropriate additional amounts of these other mineral and vitamin ingredients may be needed to provide to food products to compensate for some loss during processing and storage of such products. Additionally, those skilled in the art understand that certain micronutrients may have potential benefit for people with diabetes such as chromium, carnitine, taurine, vitamin E, etc., and that higher dietary requirements may exist for certain micro nutrients such as, for example, ascorbic acid due to higher turnover in people with diabetes, etc.

An example of a vitamin and mineral system for an embodiment of a food product used as a meal replacement may comprise, in addition to vitamin C, at least about 10% of the Recommended Daily Intake (RDI) for the vitamins A, B1, B2, B6, B12, C, D, E, K, β-carotene, biotin, folic acid, pantothenic acid, niacin, choline, etc.; in addition to iron (II) mineral sources and calcium mineral sources, one or more trace minerals, other minerals, including sodium, phosphorous, chloride, iodine chromium, molybdenum, selenium, etc.; the conditionally essential nutrients m-inositol, carnitine, taurine, etc., in a single serving of from about 50 Kcal to about 1000 Kcal.

Artificial sweeteners may also be added to the edible nutritional products or compositions to enhance the organoleptic quality of the formula. Examples of suitable artificial sweeteners may include saccharine, aspartame, acesulfame K (Ace K), sucralose (e.g., Tate & Lyle's Splenda®), etc. Embodiments of the edible nutritional products or compositions of the present invention may also include a flavoring and/or color to provide the food products with an appealing appearance and an acceptable taste for oral consumption. Examples of useful flavorings typically include, for example, strawberry, peach, butter pecan, chocolate, banana, raspberry, orange, blueberry and vanilla.

Embodiments of the edible nutritional products or compositions of the present invention may also comprise proteins. The protein source may contain intact proteins, hydrolyzed proteins, peptides, amino acids, or any combination thereof. The proteins that may be utilized in these edible nutritional products or compositions may include any edible protein suitable for human consumption. Examples of suitable proteins that may be utilized include soy proteins, milk proteins, cereal proteins, other vegetable proteins (e.g., from pea), and mixtures thereof. Commercial protein sources are readily available and known.

Embodiments of the edible nutritional products or compositions of the present invention may also comprise fat. Suitable fats or sources thereof may include any that are known for or otherwise safe for use in an oral nutritional products, non limiting examples of which include coconut oil, fractionated coconut oil, soybean oil, corn oil, peanut oil, low erucic acid rapeseed oil (canola oil), olive oil, safflower oil, high oleic safflower oil, MCT oil (medium chain triglycerides), sunflower oil, high oleic sunflower oil, sesame seed oil, palm and palm kernel oils, palm olein, marine oils, cottonseed oils, flaxseed oils, cocoa butter, and combinations thereof. Numerous commercial sources for the fats listed above are readily available and known to those skilled in the art.

The fat component may comprise in whole or in part polyunsaturated fatty acids, including polyunsaturated fatty acid esters or other natural or synthetic source, including short chain (less than about 6 carbon atoms per chain), medium chain (from about 6 to 18 carbon atoms per chain) and long chain (having at least about 20 carbon atoms per chain) fatty acids having two or more carbon:carbon double bonds, including n-3 (omega-3) and n-6 (omega-6) polyunsaturated fatty acids. Non limiting examples of polyunsaturated fatty acids suitable for use herein include alpha-linolenic acid (ALA, C18:3n-3), stearidonic acid (C18:4n-3), eicosapentaenoic acid (EPA, C20:5n-3), docosapentaenoic acid (C22:5n-3), docosahexaenoic acid (DHA, C22:6n-3), linoleic acid (C18:2n-6), gamma-linolenic acid (GLA, C18:3n-6), eicosadienoic acid (C20:2n-6), arachidonic acid (ARA, C20:4n-6), di-homo-gamma-linolenic acid (DGLA, C20:3n-6), and combinations thereof.

Embodiments of the edible nutritional products or compositions of the present invention may also comprise a flavorant, concentrations of which may vary substantially depending upon the selected flavorant and other ingredients, as well as the desired flavor profile or intensity desired. Any flavorant that is known or otherwise suitable for use in food products may be used herein, provided that such flavorant is also compatible with the other selected materials, ingredients, additives, etc.

Such flavorants may be natural or synthetic and may be provided as a single or multiple flavored materials. Flavorants for use in these edible nutritional products or compositions are most typically a combination of many ingredients to provide the desired flavor association.

Non-limiting examples of suitable flavorants include enzyme-modified flavors (e.g., dairy flavors), fermentation flavors (e.g., dairy flavors), reaction flavors (e.g., chocolate, caramel), natural extracts (e.g., vanilla, coffee, chocolate), and combinations thereof. Non-limiting examples of other specific flavorants suitable for use herein may include butter pecan flavor, orange, lemon, lime, apricot, grapefruit, yuzu, sudachi, apple, grape, strawberry, pineapple, banana peach, melon, apricot, ume, cherry, raspberry, blueberry, butter, vanilla, tea, coffee, cocoa or chocolate, mint, peppermint, spearmint, Japanese mint, asafetida, ajowan, anise, angelica, fennel, allspice, cinnamon, camomile, mustard, cardamon, caraway, cumin, clove, pepper, coriander, sassafras, savory, Zanthoxyli Fructus, perilla, juniper berry, ginger, star anise, horseradish, thyme, tarragon, dill, capsicum, nutmeg, basil, marjoram, rosemary, bayleaf, wasabi, beef, pork, chicken, fish, crustacean, dried and smoked fish, seaweed, wine, whisky, brandy, rum, gin, liqueur, floral flavors, onion, garlic, cabbage, carrot, celery, mushroom, tomato, and combinations thereof.

Embodiments of the edible nutritional products or compositions of the present invention may further comprise other optional components, materials, ingredients, additives, etc., that may modify the physical, chemical, aesthetic or processing characteristics of the edible nutritional products or compositions. Many such optional components, materials, ingredients, additives, etc., that are known or otherwise suitable for use in other edible nutritional products or compositions may also be used in the edible nutritional products or compositions herein, provided that such optional components, materials, ingredients, additives, etc., are safe for human consumption and are compatible with the essential and other components, materials, ingredients, additives, etc., present in these edible nutritional products or compositions. Non-limiting examples of other optional ingredients include preservatives, antioxidants, pharmaceutical actives or drugs, colorants, additional flavors, etc.

Embodiments of the edible nutritional products or compositions of the present invention may further comprise other vitamins or related nutrients, non-limiting examples of which include vitamin A, vitamin C (e.g., ascorbic acid which may also function as an antioxidant), vitamin D, vitamin E, vitamin K, thiamine, riboflavin, pyridoxine, vitamins B1, B₂, B₁₂, etc., carotenoids (e.g., β-carotene, zeaxanthin, lutein, lycopene), niacin, folic acid, pantothenic acid, biotin, choline, inositol, salts/conjugates and derivatives thereof, and combinations thereof.

These edible nutritional products or compositions may further comprise other (trace) minerals, non-limiting examples of which include phosphorus, sodium, potassium, molybdenum, chromium (e.g., from chromium picolinate), chloride, etc., and combinations thereof.

Embodiments of the edible nutritional products or compositions of the present invention may also be substantially free of any optional components, materials, ingredients, additives, etc., described herein. In this context, the term “substantially free” means that the selected product contains less than a functional amount of the optional components, materials, ingredients, additives, etc., including zero percent by weight of such optional components, materials, ingredients, additives, etc.

Embodiments of the present invention may also include a process for preparing these edible nutritional compositions or products, including nutritionally supplemented liquid beverage compositions or products. In this process, an aqueous solution of the one or more high ferric ion reducing agents is formed. Adding the high ferric ion reducing agents (e.g., ascorbic acid/edible ascorbic acid salts/edible ascorbic acid esters, and/or erythorbic acid/edible erythorbic acid salts/edible erythorbic acid esters) first to the aqueous solution (e.g., water) minimizes the levels of dissolved oxygen in the aqueous solution. In some embodiments of this process, other ingredients present in the final (resulting) edible nutritional composition or product (e.g., nutritionally supplemented liquid beverage composition or product) may be included in this aqueous solution of the one or more high ferric ion reducing agents. For example, sweeteners, such as sucrose, fructose, other high intensity sweeteners, etc., texturizing agents, such as starch (i.e., any plant based starch such as tapioca, corn, soy, wheat, sorghum, rice, etc., or mixtures thereof), modified food starches, dextrin, pectin, cellulose gums, food gums, etc., may be added to this aqueous solution of the one or more high ferric ion reducing agents.

To this aqueous solution of the high ferric ion reducing agents is then added a mixture of the edible carboxylic acid component (e.g., citric acid and malic acid component) and the iron (II) mineral sources. In some embodiments, an initial portion (e.g., from about 50 to about 90% of the total amount) of the edible carboxylic acid component may be combined with the high ferric ion reducing agents to form a premix. The remaining portion (e.g., from about 10 to about 50% of the total amount) of the edible carboxylic acid component may then be added to the aqueous solution of the high ferric ion reducing agents, followed by the addition to this aqueous solution of this premix of the high ferric ion reducing agents and the initial portion of the edible carboxylic acid component to provide an aqueous solution of iron (II) mineral sources in a stable high ferric ion reducing potential environment by providing a pH of about 4.5 or less (e.g., about 4.0 or less).

To this aqueous solution of iron (II) mineral sources in a stable high ferric ion reducing potential environment (which may, in some embodiments be in the form of a slurry) is then added the one or more calcium mineral sources to ameliorate the sour taste of the edible carboxylic acid component (e.g., citric acid and malic acid component) and to form with the edible carboxylic acid component a solubilized calcium complex (e.g., a solubilized calcium citrate malate complex) in this solution of iron (II) mineral sources in a high ferric ion reducing potential environment. In some embodiments where the calcium mineral source is calcium hydroxide or calcium carbonate, the calcium hydroxide or calcium carbonate may be slowly added (to minimize, reduce, diminish, prevent, etc., a rapid rise in solution temperature in the case of calcium hydroxide, or in the case of calcium carbonate, to accommodate the potential evolution of carbon dioxide) to this aqueous solution of iron (II) mineral sources in a stable high ferric ion reducing potential environment. To this aqueous solution of iron (II) mineral sources in a stable high ferric ion reducing potential environment containing the solubilized calcium complex is then added any remaining components of the edible nutritional composition or product (e.g., nutritionally supplemented liquid beverage composition or product), such as, for example, fruit juices or fruit juice concentrates (including those high in anthocyanins), other minerals (e.g., zinc, magnesium, manganese, copper, etc.), vitamins (e.g., vitamin A, vitamin D, etc.), preservatives, flavors, etc.

### EXAMPLES

Illustrative examples of embodiments of edible nutritional products or compositions are shown below:

### Example 1

A mineral fortified fruit juice beverage is formulated from the following ingredients (Table 1):

TABLE 1

| Ingredient | % w/w |
|---|---|
| Sucrose | 5.0 |
| Ace K | 0.080 |
| Ferrous bis-glycinate (20% Iron) | 0.011 |
| Ascorbic Acid | 0.084 |
| Erythorbic Acid | 0.055 |
| Calcium Hydroxide | 0.23 |
| Citric Acid | 0.419 |
| Malic Acid | 0.439 |
| Vitamin A Palmitate | 0.0016 |
| Vitamin D 100 | 0.0008 |
| Black Currant Juice 65° Brix | 1.19 |
| Potassium Sorbate | 0.042 |
| Flavor | 0.20 |

For a 1 gallon batch, ascorbic acid (3.36 g) and erythorbic acid (2.20 g) is added to water (3620 g). Sucrose (200 g) and Ace K (3.2 g) are added to the solution until dissolved. Ferrous bis-glycinate (0.44 g) is mixed with an initial portion of the citric and malic acids (3.8 g and 3.6 g, respectively). The remaining portion of citric and malic acids (13 g and 14 g, respectively) are added to the solution followed by the ferrous bis-glycinate-initial acid portion mixture. After complete dissolution, the calcium hydroxide (9.21 g) is slowly added to the solution and mixed until the reaction is complete, i.e., clear solution. The final juice concentrate, as well as the other vitamins and flavor ingredients are then added to complete the final batch. Typically, physical parameters are measured, for example, Brix, acid, etc., to meet target specifications.

### Example 2

A mineral fortified fruit juice concentrate, dilutable 1 to 4 in water to provide finished single-strength equivalence drink, is formulated from the following ingredients (Table 2):

TABLE 2

| Ingredient | % w/w |
|---|---|
| Sucrose | 25.0 |
| Ace K | 0.40 |
| Ferrous bis-glycinate (20% Iron) | 0.055 |
| Ascorbic Acid | 0.420 |
| Erythorbic Acid | 0.275 |
| Calcium Hydroxide | 1.15 |
| Citric Acid | 0.90 |
| Malic Acid | 2.98 |
| Vitamin A Palmitate | 0.008 |
| Vitamin D 100 | 0.004 |
| Black Currant Juice 65° Brix | 5.95 |
| Potassium Sorbate | 0.042 |
| Flavor | 0.20 |

For a 1 gallon batch, ascorbic acid (16.8 g) and erythorbic acid (11.0 g) is added to water (2086 g). Sucrose (1001 g) and Ace K (16.0 g) are added to the solution until dissolved. The ferrous bis-glycinate, 2.2 g is mixed with an initial portion of the citric and malic acids (7.1 g and 23.8 g, respectively). The remaining portion of the citric and malic acids (29 g and 95.5 g, respectively) are added to the solution followed by the ferrous bis-glycinate-initial acid portion mixture. After complete dissolution, calcium hydroxide (46.1 g) is slowly added to the solution and mixed until the reaction is complete, i.e., clear solution. The final juice concentrate, as well as the other vitamins and flavor ingredients, are added to complete the final batch. Typically, physical parameters are measured, for example, Brix, acid, etc., to meet target specifications.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

1. A product comprising an aqueous liquid edible nutritional composition containing:
a nutritionally supplemental amount of one or more iron (II) mineral sources;
one or more edible high ferric ion reducing agents in amount sufficient to measurably retard conversion of the iron (II) mineral sources from ferrous to ferric species and to form a stable high ferric ion reducing potential environment for the iron (II) mineral sources in the edible nutritional composition;
an edible carboxylic acid component in an amount sufficient to lower the pH of the edible nutritional composition to about 4.5 or less; and
one or more calcium mineral sources which form a can be solubilized calcium complex with by the edible carboxylic acid component in the edible nutritional composition and which are in an amount sufficient to ameliorate the sour taste of the edible carboxylic acid component.

2. The product of claim 1, wherein the edible nutritional composition contains from about 7 to 40 ppm (iron metal basis) by weight of the iron (II) mineral sources.

3. The product of claim 2, wherein the edible nutritional composition contains from about 7 to 25 ppm (iron metal basis) by weight of the iron (II) mineral sources.

4. The product of claim 1, wherein the iron (II) mineral sources comprise one or more of: ferrous bis-glycinate, ferrous glycine sulfate, ferrous fumarate, ferrous gluconate, ferrous succinate, ferrous lactate, ferrous tartrate, ferrous citrate, ferrous sulfate, ferrous ammonium sulfate, or ferrous iodide.

5. The product of claim 4, wherein the iron (II) mineral sources comprise ferrous bis-glycinate.

6. The product of claim 1, wherein the high ferric ion reducing agents comprise one or more of: ascorbic acid, edible ascorbic acid salts, edible ascorbic acid esters, erythorbic acids, edible erythorbic acid salts, or edible erythorbic acid esters.

7-8. (canceled)

9. The product of claim 6 8, wherein the edible nutritional composition contains from about 350 to about 850 ppm of one or more of: ascorbic acid or ascorbic acid salts.

10-11. (canceled)

12. The product of claim 6, wherein the edible nutritional composition contains from about 200 to about 600 ppm of one or more of: erythorbic acid or erythorbic acid salts.

13-14. (canceled)

15. The product of claim 1, wherein the edible carboxylic acid component comprises citric acid and malic acid, and wherein the edible nutritional composition contains from about 0.40 to about 1.20% by weight combined citric acid and malic acid, and wherein the citric acid to malic acid is in a weight ratio of from about 5:4 to about 1:3.

16-19. (canceled)

20. The product of claim 1, wherein the edible nutritional composition contains the calcium mineral sources in an amount sufficient to provide from about 0.04 to about 0.22% solubilized calcium by weight.

21. (canceled)

22. The product of claim 20, wherein the calcium mineral sources comprise one or more of: calcium hydroxide or calcium carbonate.

23-24. (canceled)

25. The product of claim 1, wherein the pH is from about 2.1 to about 4.5.

26. A product comprising a nutritionally supplemented aqueous liquid beverage composition having a pH of about 4.0 or less, and containing:
a nutritionally supplemental amount of one or more iron (II) mineral sources;
one or more edible high ferric ion reducing agents selected from the group consisting of ascorbic acid, edible ascorbic acid salts, edible ascorbic acid esters, erythorbic acid, edible erythorbic acid salts, and edible erythorbic acid esters in amount sufficient to measurably retard conversion of the iron (II) mineral sources from ferrous to ferric species and to form a stable high ferric ion reducing potential environment for the iron (II) mineral sources in the liquid beverage composition;
an citric acid and malic acid component in an amount sufficient to lower the pH of the composition to about 4.0 or less, and in a weight ratio of citric acid to malic acid of from about 2:1 to about 1:4; and
one or more calcium mineral sources which form a solubilized calcium complex with the citric acid and malic acid component in the liquid beverage composition and which are in an amount sufficient to ameliorate the sour taste of the citric acid and malic acid component.

27. The product of claim 26, wherein the liquid beverage composition further contains fruit juice from one or more of the following fruits: blueberries, cranberry, bilberry, black raspberry, red raspberry, blackberry, black currant, cherry, concord grape, black chokeberry, or acai, wherein the fruit juice is in an amount sufficient to provide anthocyanins in an amount of at least about 2% by weight of the liquid beverage composition to impart one or more of: color or flavor.

28. The product of claim 26, wherein the liquid beverage composition further contains fruit juice in an amount of at least about 5% by weight (single strength basis).

29-32. (canceled)

33. The product of claim 26, wherein the liquid beverage composition contains from about 7 to about 25 ppm (iron metal basis) by weight of the iron (II) mineral sources, and wherein the iron (II) mineral sources comprise ferrous bis-glycinate.

34. (canceled)

35. The product of claim 26, wherein the liquid beverage composition contains from about 600 to about 850 ppm of one or more of: ascorbic acid or ascorbic acid salts.

36. The product of claim 26, wherein the liquid beverage composition contains from about 500 to about 600 ppm one or more of: erythorbic acid or erythorbic acid salts.

37. (canceled)

38. The product of claim 26, wherein the liquid beverage composition contains from about 0.18 to about 0.60% by weight of the citric acid and from about 0.22 to about 0.60% by weight malic acid.

39. (canceled)

40. The product of claim 26, wherein the liquid beverage composition contains the calcium mineral sources in an amount sufficient to provide from about 0.04 to about 0.22% solubilized calcium by weight, and wherein the calcium mineral sources comprise one or more of: calcium hydroxide or calcium carbonate.

41. (canceled)

42. The product of claim 26, wherein the pH is from about 3.4 to about 3.8.

43. The product of claim 26, wherein the product is in the form of a liquid mineral fortified concentrate which is dilutable in a volume ratio of concentrate:water of from about 1:1 to about 1:4.

44. A process for preparing an aqueous liquid edible nutritional composition, which comprises the following steps:
(a) combining a mixture of an edible carboxylic acid component in an amount sufficient to lower the pH of the edible nutritional composition to about 4.5 or less, and a nutritionally supplemental amount of one or more iron (II) mineral sources, with an aqueous solution of one or more edible high ferric ion reducing agents in an amount sufficient to measurably retard conversion of iron (II) mineral sources from ferrous to ferric species to provide a solution of iron (II) mineral sources in a stable high ferric ion reducing potential environment;
(b) combining one or more calcium mineral sources which can be solubilized by the edible carboxylic acid component with the solution of step (a) in an amount sufficient to ameliorate the sour taste of the edible carboxylic acid component and to form a solution comprising a solubilized calcium complex with the edible carboxylic acid component; and
(c) combining with the solution of step (b) any remaining components of the edible nutritional composition to provide a prepared edible nutritional composition having a pH of about 4.5 or less.

45. The process of claim 44, wherein step (a) is carried out by combining an initial portion of from about 50 to about 90% of the edible carboxylic acid component with the iron (II) mineral sources to provide a premix, adding the remaining portion of from about 10 to about 50% of the edible carboxylic acid component to the aqueous solution of high ferric ion reducing agents, following by adding the premix to the aqueous solution of high ferric ion reducing agents containing the remaining portion of the edible carboxylic acid component.

46. The process of claim 44, wherein the iron (II) mineral sources of step (a) comprise one or more of: ferrous bis-glycinate, ferrous glycine sulfate, ferrous fumarate, ferrous gluconate, ferrous succinate, ferrous lactate, ferrous tartrate, ferrous citrate, ferrous sulfate, ferrous ammonium sulfate, or ferrous iodide.

47. The process of claim 46, wherein the iron (II) mineral sources of step (a) comprise ferrous bis-glycinate.

48. The process of claim 44, wherein the high ferric ion reducing agents of step (a) comprise one or more of: ascorbic acid, edible ascorbic acid salts, edible ascorbic acid esters, erythorbic acids, edible erythorbic acid salts, or edible erythorbic acid esters.

49. (canceled)

50. The process of claim 44, wherein the edible carboxylic acid component of step (a) comprises citric acid and malic acid in a weight ratio of from about 5:4 to about 1:3.

51. (canceled)

52. The process of claim 50, wherein the edible carboxylic acid component of step (a) is in an amount sufficient to lower the pH of the edible nutritional composition to from about 3.4 to about 3.8.

53. (canceled)

54. The process of claim 44 53, wherein the calcium mineral sources of step (b) comprise one or more of: calcium hydroxide or calcium carbonate.

55. The process of claim 44, wherein the remaining components of step (c) comprise anthocyanins in an amount sufficient to impart to the prepared edible nutritional composition one or more of: color or flavor; and wherein the anthocyanins are present in the remaining components of step (c) in an amount of at least about 2% by weight of the prepared edible nutritional composition.

56-61. (canceled)
